(19) United States
(12) Patent Application Publication
(10) Pub. No.: US 2025/0076595 A1
(43) Pub. Date: Mar. 6, 2025

(54) LIGHT RECEIVER, COMMUNICATION DEVICE, AND COMMUNICATION SYSTEM

(71) Applicant: NEC Corporation, Tokyo (JP)

(72) Inventors: Masaki AIZONO, Tokyo (JP); Atsushi KAMOI, Tokyo (JP); Fujio OKUMURA, Kanagawa (JP)

(73) Assignee: NEC Corporation, Tokyo (JP)

(21) Appl. No.: 18/772,223

(22) Filed: Jul. 14, 2024

(30) Foreign Application Priority Data
Aug. 31, 2023 (JP) 2023-140698

(51) Int. Cl. G02B 6/42

(52) U.S. Cl. CPC G02B 6/4215; G02B 6/4206; G02B 6/4214

(57) ABSTRACT

Provided is a light receiver that includes a ball lens, an irradiation position detector that detects an irradiation position of a signal light condensed by the ball lens, a wavelength separator that wavelength-separates a signal light having a plurality of wavelengths used for spatial optical communication from a signal light condensed by the ball lens, and a light receiving element group including a plurality of communication light receiving elements that receive a signal light having the plurality of wavelengths wavelength-separated by the wavelength separator.

This application is based upon and claims the benefit of priority from Japanese Patent Application No. 2023-140698, filed on Aug. 31, 2023, the disclosure of which is incorporated herein in its entirety by reference.

### TECHNICAL FIELD

The present disclosure relates to a light receiver, a communication device, and a communication system.

### BACKGROUND ART

In spatial optical communication, a wavelength selection filter is attached to a plurality of photodiodes, so that a wavelength-multiplexed spatial optical signal can be received. The plurality of photodiodes are arranged side by side in the condensing range in front of the focal position of the lens. When the plurality of photodiodes are arranged as described above, the light receiving area of the photodiode for each wavelength decreases, and the light receiving intensity of the spatial optical signal decreases.

PTL 1 (JP 2016-012839 A) discloses a space division device intended to selectively receive any light beam among light beams from a plurality of light sources in optical communication in a free space. The device of PTL 1 includes a liquid crystal disposed on a planar space. The device of PTL 1 is disposed in front of the light receiver. The device of PTL 1 selectively receives any light beam among light beams from a plurality of light sources by changing the transmittance for each pixel of the liquid crystal and switching introduction of a plurality of light beams incident on the liquid crystal to the light receiver.

The wavelength-multiplexed spatial optical signal is emitted from a light source different for each wavelength. Therefore, the irradiation position of the signal light condensed by the lens is shifted for each wavelength. In the method of PTL 1, the deviation of the irradiation position of the signal light is not corrected. Therefore, in the method of PTL 1, it is not always possible to receive the wavelength-multiplexed spatial optical signal with sufficient intensity.

An object of the present disclosure is to provide a light receiver, a communication device, and a communication system capable of receiving a wavelength-multiplexed spatial optical signal with sufficient intensity.

### SUMMARY

A light receiver according to one aspect of the present disclosure includes a ball lens, an irradiation position detector that detects an irradiation position of a signal light condensed by the ball lens, a wavelength separator that wavelength-separates a signal light having a plurality of wavelengths used for spatial optical communication from a signal light condensed by the ball lens, and a light receiving element group including a plurality of communication light receiving elements that receive a signal light having the plurality of wavelengths wavelength-separated by the wavelength separator.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a communication device in the present disclosure;

FIG. 2 is a block diagram illustrating an example of a configuration of a light receiver in the present disclosure;

FIG. 3 is a conceptual diagram illustrating an example of incidence of a spatial optical signal on a light receiver in the present disclosure;

FIG. 4 is a conceptual diagram illustrating an example of a configuration of a light receiver in the present disclosure;

FIG. 5 is a conceptual diagram illustrating an example of a configuration of a light receiver in the present disclosure;

FIG. 6 is a conceptual diagram illustrating an example of a configuration of a light receiver in the present disclosure;

FIG. 7 is a conceptual diagram illustrating an example of a configuration of a wavelength separator in the present disclosure;

FIG. 8 is a conceptual diagram illustrating an example of a configuration of a wavelength separator in the present disclosure;

FIG. 9 is a conceptual diagram illustrating an example of a configuration of a wavelength separator in the present disclosure;

FIG. 10 is a conceptual diagram illustrating an example of a configuration of a light transmitter in the present disclosure;

FIG. 11 is a block diagram illustrating an example of a configuration of a communication control device in the present disclosure;

FIG. 12 is a conceptual diagram for explaining direction detection of an arrival direction of a spatial optical signal by a communication device in the present disclosure;

FIG. 13 is a conceptual diagram illustrating an example of a configuration of a detector in the present disclosure;

FIG. 14 is a conceptual diagram for explaining an example of a communication establishment in the present disclosure;

FIG. 15 is a flowchart for explaining an example of communication establishment in the present disclosure;

FIG. 16 is a conceptual diagram illustrating an example of a configuration of an irradiation position detector in the present disclosure;

FIG. 17 is a conceptual diagram illustrating an example of a configuration of a direction detection circuit in the present disclosure;

FIG. 18 is a conceptual diagram illustrating an example of a configuration of an irradiation position detector in the present disclosure;

FIG. 19 is a conceptual diagram illustrating an example of a configuration of a direction detection circuit in the present disclosure;

FIG. 20 is a conceptual diagram for explaining an application example of a communication network including a communication device in the present disclosure;

FIG. 21 is a block diagram illustrating an example of a configuration of a light receiver in the present disclosure; and

FIG. 22 is a block diagram illustrating an example of a hardware configuration that executes processing and control in each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. Aline indicating a trajectory of light in the drawings is conceptual and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated, or the configuration is complicated.

### First Example Embodiment

First, a reception device according to a first example embodiment will be described with reference to the drawings. The communication device of the present example embodiment is used for optical spatial communication in which spatial optical signals propagating in a space are transmitted and received. The communication device according to the present example embodiment performs communication using a spatial optical signal (wavelength-multiplexed spatial optical signal) obtained by multiplexing light of a plurality of wavelength bands. The communication device of the present example embodiment may be used for applications other than optical spatial communication as long as the communication device transmits and receives light propagating in a space. The drawings used in the description of the present example embodiment are conceptual and do not accurately depict an actual structure.

### (Configuration)

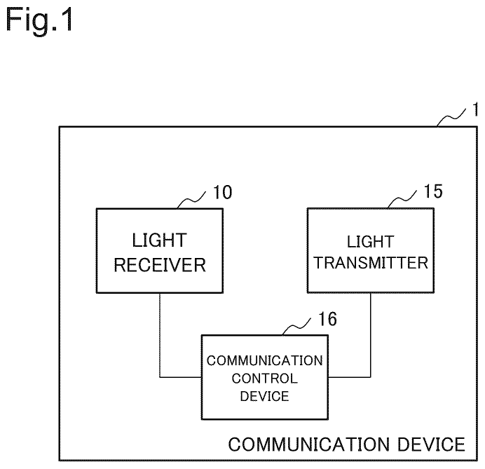

FIG. 1 is a block diagram illustrating an example of a configuration of a communication device 1 in the present disclosure; The communication device 1 includes a light receiver 10, a light transmitter 15, and a communication control device 16. Hereinafter, each of the light receiver 10, the light transmitter 15, and the communication control device 16 will be individually described. In the present example embodiment, an example in which spatial optical communication using a spatial optical signal is performed with another communication device 1 as a communication target will be described. In the present example embodiment, an example in which a phase modulation-type spatial light modulator is included in the light transmitter 15 will be described.

### [Light Receiver]

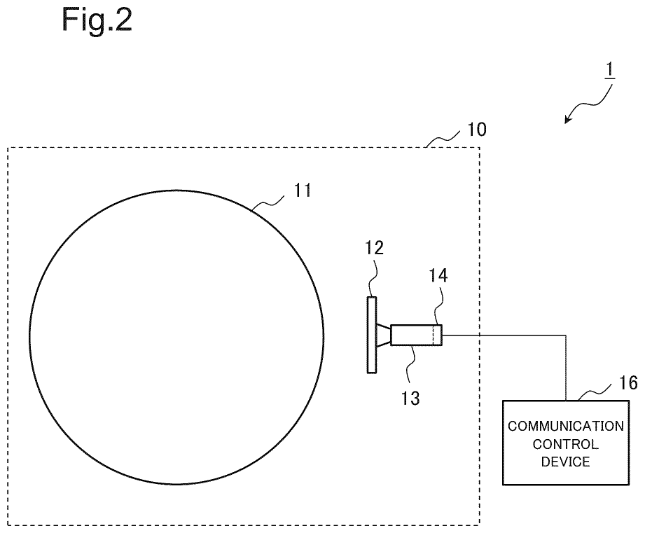

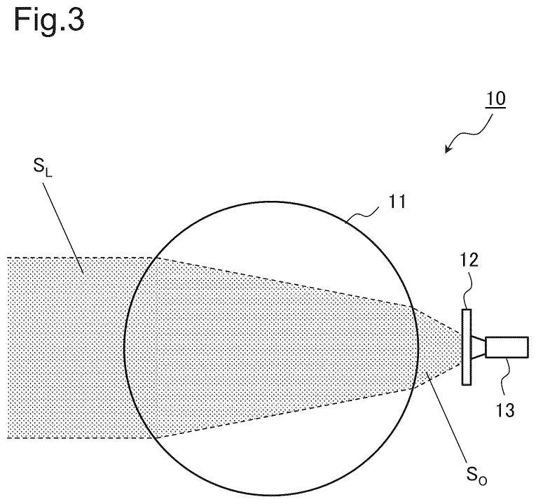

FIG. 2 is a block diagram illustrating an example of a configuration of the light receiver 10 in the present disclosure. FIG. 3 is a conceptual diagram illustrating an example of reception of a spatial optical signal by the light receiver 10 in the present disclosure. FIGS. 2 and 3 are conceptual diagrams illustrating an internal configuration of the light receiver 10 as viewed from a side. The light receiver 10 includes a ball lens 11, an irradiation position detector 12, a wavelength separator 13, and a light receiving element group 14.

The irradiation position detector 12 includes a plurality of direction detecting light receiving elements used to detect the irradiation position of the signal light. The wavelength separator 13 includes a component for wavelength-separating the wavelength-multiplexed signal light. The wavelength separator 13 includes a communication light receiving element for each wavelength band to be received. FIGS. 2 and 3 illustrate a conceptual positional relationship between the irradiation position detector 12 and the wavelength separator 13. Detailed configurations and the like of the irradiation position detector 12 and the wavelength separator 13 will be described later.

The spatial optical signal S_{L} arriving at the light receiver 10 is condensed by the ball lens 11. The irradiation position detector 12 is irradiated with light (signal light S_{O}) derived from the spatial optical signal S_{L} condensed by the ball lens 11. The irradiation position of the signal light S_{O} is detected by the communication control device 16. The communication control device 16 causes the light transmitter 15 to transmit the spatial optical signal including a request for changing the transmission direction of the spatial optical signal S_{L} such that the signal light S_{O} is guided by the wavelength separator 13 and the light receiving element group 14 according to the irradiation position of the signal light S_{O}. In response to the request for changing the transmission direction of the spatial optical signal S_{L}, the communication target adjusts the transmission direction of the spatial optical signal. The signal light S_{O} derived from the spatial optical signal S_{L} of which the transmission direction is adjusted is introduced into the wavelength separator 13 through the through hole of the irradiation position detector 12. The signal light S_{O} introduced into the wavelength separator 13 is separated for each wavelength band. The signal light S_{O} separated for each wavelength band is received by a communication light receiving element allocated for each wavelength band.

The ball lens 11 is supported by a support portion (not illustrated). The ball lens 11 is a spherical lens. The ball lens 11 is an optical element that collects a spatial optical signal arriving from the outside. The ball lens 11 has a spherical shape as viewed from any angle. The ball lens 11 condenses the incident spatial optical signal. A signal light derived from the spatial optical signal condensed by the ball lens 11 is condensed toward the condensing region of the ball lens 11. Since the ball lens 11 has a spherical shape, the ball lens collects a spatial optical signal arriving from any direction. That is, the ball lens 11 exhibits similar light condensing performance for a spatial optical signal arriving from any direction. The light incident on the ball lens 11 is refracted when entering the inside of the ball lens 11. The light traveled inside the ball lens 11 is refracted again when being emitted to the outside of the ball lens 11. Most of the light emitted from the ball lens 11 is condensed toward the condensing region.

For example, the ball lens 11 can be made of a material such as glass, crystal, or resin. In the case of receiving a spatial optical signal in the visible region, the ball lens 11 can be achieved by a material that transmits/refracts light in the visible region. For example, the ball lens 11 can be achieved by optical glass such as crown glass or flint glass. For example, the ball lens 11 can be achieved by a crown glass such as Boron Kron (BK). For example, the ball lens 11 can be achieved by a flint glass such as Lanthanum Schwerflint (LaSF). For example, quartz glass can be applied to the ball lens 11. For example, a crystal such as sapphire can be applied to the ball lens 11. For example, a transparent resin such as acrylic can be applied to the ball lens 11.

In a case where the spatial optical signal is light in a near-infrared region (hereinafter, also referred to as near-infrared rays), a material that transmits near-infrared rays is used for the ball lens 11. For example, in a case of receiving a spatial optical signal in a near-infrared region of about 1.5 micrometers (m), a material such as silicon can be applied to the ball lens 11 in addition to glass, crystal, resin, and the like. In a case where the spatial optical signal is light in an infrared region (hereinafter, also referred to as infrared rays), a material that transmits infrared rays is used for the ball lens 11. For example, in a case where the spatial optical signal is an infrared ray, silicon, germanium, or a chalcogenide material can be applied to the ball lens 11. The material of the ball lens 11 is not limited as long as light in the wavelength region of the spatial optical signal can be transmitted/refracted. The material of the ball lens 11 may be appropriately selected according to the required refractive index and use.

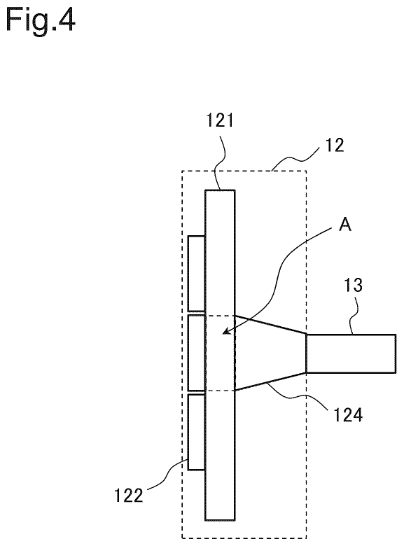

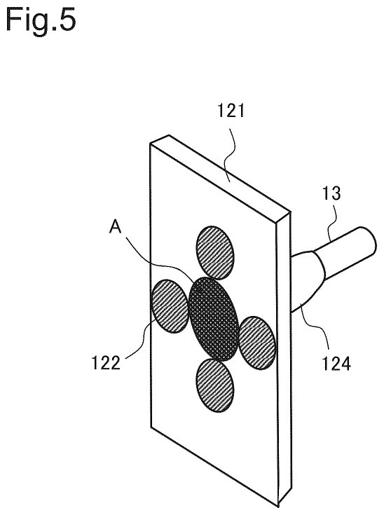

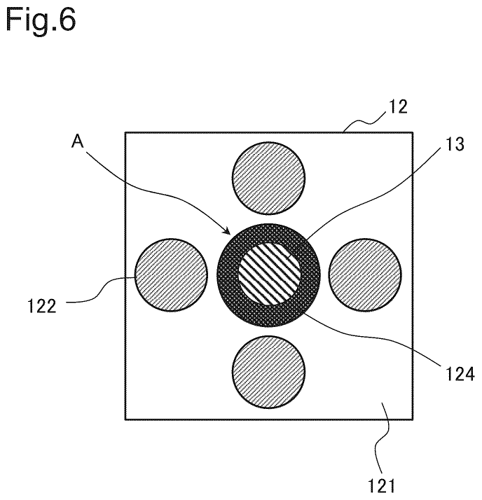

The irradiation position detector 12 is disposed in the condensing region of the ball lens 11. FIGS. 4 to 6 are conceptual diagrams illustrating an example of a configuration of the irradiation position detector 12 of the present disclosure. FIG. 4 is a side view of the irradiation position detector 12 as viewed from a side. FIG. 5 is a perspective view of the light receiving surface of the irradiation position detector 12 as viewed obliquely from above. FIG. 6 is a front view of the light receiving surface of the irradiation position detector 12 as viewed from a side of the ball lens 11. The irradiation position detector 12 includes a substrate 121, a direction detecting light receiving element 122, and a light guide tube 124. The irradiation position detector 12 includes a plurality of direction detecting light receiving elements 122. In the example of FIGS. 3 to 5, the irradiation position detector 12 includes four direction detecting light receiving elements 122. The number of the direction detecting light receiving elements 122 is not limited to four.

The substrate 121 is a substrate used for a printed circuit board. A through hole A is formed in the substrate 121. The opening diameter of the through hole A is formed in accordance with the size of the incident end (the opening end on the left side in FIG. 4) of the light guide tube 124. On the incident surface (the surface on the left side in FIG. 4) of the substrate 121, a plurality of direction detecting light receiving elements 122 are arranged around the through hole A. In the example of FIGS. 4 to 6, four direction detecting light receiving elements 122 are arranged around the through hole A. The substrate 121 may be omitted as long as the positional relationship among the plurality of direction detecting light receiving elements 122 can be maintained and the optical signal condensed by the ball lens 11 can be efficiently guided to the wavelength separator 13.

The plurality of direction detecting light receiving elements 122 are arranged on the incident surface (the surface on the left side in FIG. 4) of the substrate 121. The plurality of direction detecting light receiving elements 122 are arranged on the circumference of a circle centered on the through hole A of the substrate 121. The light receiving part of the direction detecting light receiving element 122 faces the ball lens 11. The direction detecting light receiving element 122 has sensitivity to light in a wavelength band of a spatial optical signal used for searching for a communication target. For example, the direction detecting light receiving element 122 is achieved by a photodiode having sensitivity to infrared rays. For example, the direction detecting light receiving element 122 is achieved by an indium gallium arsenide (InGaAs)-based photodiode. For example, the communication light receiving element is achieved by an InGaAs-based photodiode. Since the direction detecting light receiving element 122 only needs to be able to detect the spatial optical signal, the speed may be lower than that of the communication light receiving element. Therefore, the direction detecting light receiving element 122 may be achieved by a germanium (Ge)-based or silicon (Si)-based photodiode. The silicon-based photodiode is used in a wavelength band of 1000 nm from visible light. On the other hand, an InGaAs-based photodiode is used in a wavelength band of 1300 to 1550 nm. The silicon-based photodiode and the InGaAs-based photodiode are selected according to a wavelength of a spatial optical signal used for communication. The spatial optical signal received by the direction detecting light receiving element 122 is converted into an electric signal. The converted electric signal is output to the communication control device 16. In a case where the communication control device 16 includes an integrator (not illustrated), the converted electric signal is supplied to the integrator included in the communication control device 16. The electrical signal supplied to the integrator is integrated to a level detectable by the communication control device 16.

The light guide tube 124 is a tubular member having an incident end and an emission end. The incident end (the opening end on the left side in FIG. 4) is formed in accordance with the size of the opening diameter of the through hole A. The emission end (the opening end on the right side in FIG. 4) has a smaller opening diameter than the incidence end. The opening diameter of the emission end is formed in accordance with the inner diameter of the wavelength separator 13. A material and a shape of the light guide tube 124 are not particularly limited. For example, a reflecting surface that reflects a signal light may be formed on the inner surface of the light guide tube 124. For example, a light absorbing material for reducing irregular reflection of a signal light may be disposed on the inner surface of the light guide tube 124. The light guide tube 124 may be omitted as long as the optical signal condensed by the ball lens 11 can be efficiently guided to the wavelength separator 13.

The wavelength separator 13 separates the wavelength-multiplexed spatial optical signal (signal light) for each wavelength band. The incident port of the wavelength separator 13 is connected to the emission end (the opening end on the right side in FIG. 4) of the light guide tube 124. The wavelength separator 13 includes a configuration for wavelength-separating light. For example, the wavelength separator 13 includes at least one dichroic mirror. For example, the wavelength separator 13 includes at least one convex lens. For example, the wavelength separator 13 includes at least one concave lens. For example, the wavelength separator 13 includes at least one dichroic cross prism.

The wavelength separator 13 includes a plurality of communication light receiving elements. Each of the plurality of communication light receiving elements is associated with one of the wavelength bands of the wavelength-multiplexed spatial optical signal used for communication. The wavelength-separated signal light is incident on each of the plurality of communication light receiving elements. The communication light receiving element has sensitivity to light in a wavelength band of a spatial optical signal to be communicated. For example, the communication light receiving element is achieved by a photodiode having sensitivity to infrared rays. For example, in the communication light receiving element, a spatial optical signal received by the communication light receiving element achieved by an indium gallium arsenide (InGaAs)-based or silicon-based photodiode is converted into an electric signal. The converted electric signal is output to the communication control device 16.

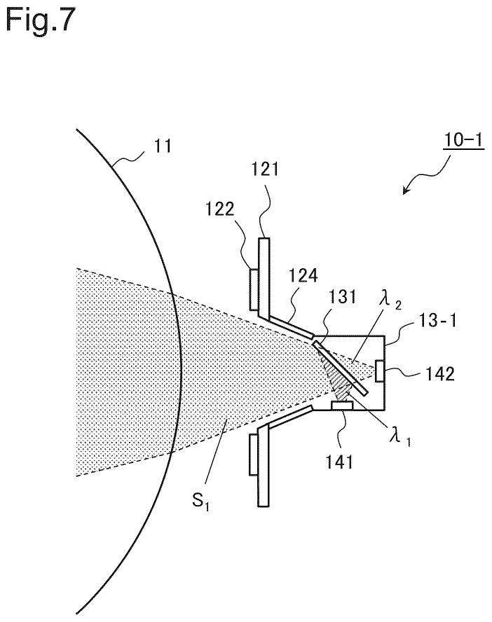

FIG. 7 is a conceptual diagram illustrating a reception example of a signal light S₁ derived from the wavelength-multiplexed spatial optical signal. The signal light S₁ is multiplexed in two wavelength bands (wavelength λ₁, wavelength λ₂). FIG. 7 is a partial cross-sectional view of an example (light receiver 10-1) of the light receiver 10 as viewed from a side. The light receiver 10-1 includes a wavelength separator 13-1. The wavelength separator 13-1 includes a dichroic mirror 131, a communication light receiving element 141, and a communication light receiving element 142. The reflecting surface of the dichroic mirror 131 reflects a signal light having the wavelength λ₁ (first wavelength). The signal light having the wavelength λ₂ (second wavelength) passes through the dichroic mirror 131. The communication light receiving element 141 (first communication light receiving element) is sensitive to light having the wavelength λ₁ (first wavelength). The communication light receiving element 142 (second communication light receiving element) is sensitive to light having the wavelength λ₂ (second wavelength).

In FIG. 7, the reflecting surface of the dichroic mirror 131 is inclined downward at an angle of 45 degrees with respect to the incident axis of the signal light S₁. The communication light receiving element 141 is disposed below the dichroic mirror 131. The light receiving part of the communication light receiving element 141 faces the reflecting surface of the dichroic mirror 131 disposed above. The signal light having the wavelength λ₁ reflected by the reflecting surface of the dichroic mirror 131 is received by the communication light receiving element 141.

The communication light receiving element 142 is disposed at a subsequent stage of the dichroic mirror 131. The light receiving part of the communication light receiving element 142 faces the back surface of the dichroic mirror 131. The signal light having the wavelength λ₂ transmitted through the dichroic mirror 131 is received by the communication light receiving element 142.

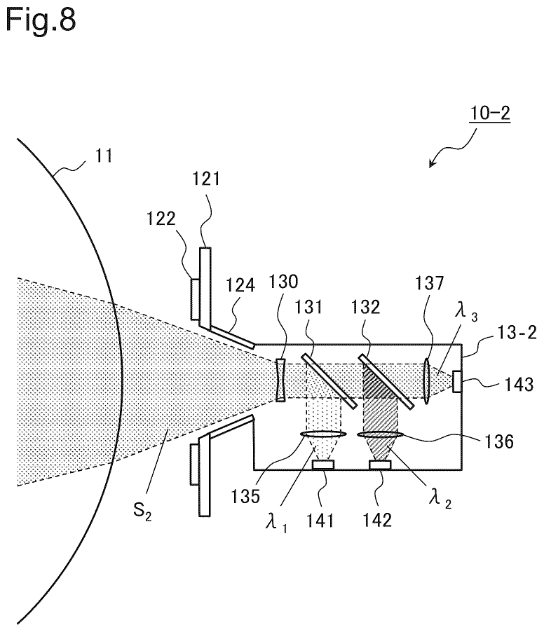

FIG. 8 is a conceptual diagram illustrating a reception example of a signal light S₂ derived from the wavelength-multiplexed spatial optical signal. The signal light S₂ is multiplexed in three wavelength bands (wavelength λ₁, wavelength λ₂, wavelength λ₃). FIG. 8 is a partial cross-sectional view of an example (light receiver 10-2) of the light receiver 10 as viewed from a side. The light receiver 10-2 includes a wavelength separator 13-2. The wavelength separator 13-2 includes a concave lens 130, a dichroic mirror 131, a dichroic mirror 132, a convex lens 135, a convex lens 136, a convex lens 137, a communication light receiving element 141, a communication light receiving element 142, and a communication light receiving element 143. The reflecting surface of the dichroic mirror 131 reflects a signal light having the wavelength λ₁ (first wavelength). The signal light having the wavelength λ₂ (second wavelength) and the wavelength λ₃ (third wavelength) passes through the dichroic mirror 131. The reflecting surface of the dichroic mirror 132 reflects a signal light having the wavelength λ₂ (second wavelength). The signal light having the wavelength λ₃ (third wavelength) passes through the dichroic mirror 132. The communication light receiving element 141 (first communication light receiving element) is sensitive to light having the wavelength λ₁ (first wavelength). The communication light receiving element 142 (second communication light receiving element) is sensitive to light having the wavelength λ₂ (second wavelength). The communication light receiving element 143 (third communication light receiving element) is sensitive to light having the wavelength λ₃ (third wavelength).

In FIG. 8, the concave lens 130 is disposed at an incident port of the wavelength separator 13-2. The incident surface of the concave lens 130 faces the ball lens 11. The signal light S₂ incident on the concave lens 130 is emitted from the emission surface. The emitted signal light S₂ travels along the optical axis of the concave lens 130.

The dichroic mirror 131 (first dichroic mirror) is disposed at a subsequent stage of the concave lens 130. The reflecting surface of the dichroic mirror 131 is inclined downward at an angle of 45 degrees with respect to the incident axis of the signal light S₂. The reflecting surface of the dichroic mirror 131 reflects the signal light having the wavelength λ₁. The signal light having the wavelength λ₂ and the signal light having the wavelength λ₃ are transmitted through the dichroic mirror 131. The convex lens 135 is disposed below the dichroic mirror 131. An incident surface of the convex lens 135 faces a reflecting surface of the upper dichroic mirror 131. The communication light receiving element 141 is disposed below the convex lens 135. The light receiving part of the communication light receiving element 141 faces the emission surface of the convex lens 135 disposed above. The signal light having the wavelength λ₁ reflected by the reflecting surface of the dichroic mirror 131 is condensed by the convex lens 135 and received by the communication light receiving element 141.

The dichroic mirror 132 (second dichroic mirror) is disposed at a subsequent stage of the dichroic mirror 131. The reflecting surface of the dichroic mirror 132 is inclined downward at an angle of 45 degrees with respect to the incident axis of the signal light S₂. The reflecting surface of the dichroic mirror 132 reflects the signal light having the wavelength λ₂. The signal light having the wavelength λ₃ is transmitted through the dichroic mirror 132. The convex lens 136 is disposed below the dichroic mirror 132. The incident surface of the convex lens 136 faces the reflecting surface of the upper dichroic mirror 132. The communication light receiving element 142 is disposed below the convex lens 136. The light receiving part of the communication light receiving element 142 faces the emission surface of the convex lens 136 disposed above. The signal light having the wavelength λ₂ reflected by the reflecting surface of the dichroic mirror 132 is condensed by the convex lens 136 and received by the communication light receiving element 142.

The convex lens 137 is disposed at a subsequent stage of the dichroic mirror 132. The incident surface of the convex lens 137 faces the back surface of the dichroic mirror 132. The communication light receiving element 143 is disposed at a subsequent stage of the convex lens 137. The light receiving part of the communication light receiving element 143 faces the emission surface of the convex lens 137. The signal light having the wavelength λ₃ transmitted through the dichroic mirror 132 is condensed by the convex lens 137 and received by the communication light receiving element 143.

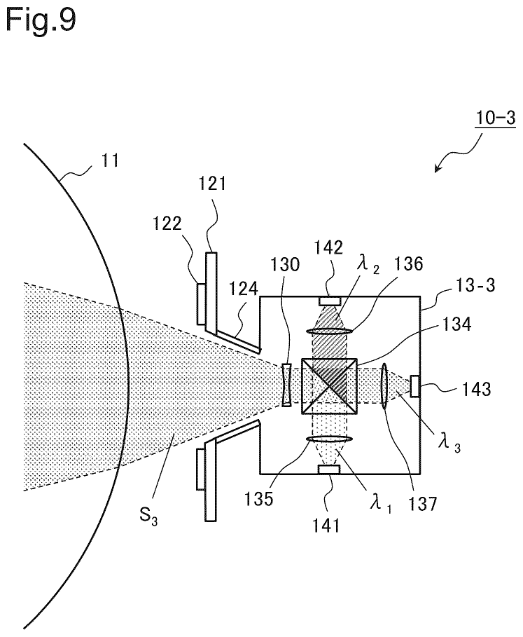

FIG. 9 is a conceptual diagram illustrating a reception example of a signal light S₃ derived from the wavelength-multiplexed spatial optical signal. The signal light S₃ is multiplexed in three wavelength bands (wavelength λ₁, wavelength λ₂, wavelength λ₃). FIG. 9 is a partial cross-sectional view of an example (light receiver 10-3) of the light receiver 10 as viewed from a side. The light receiver 10-3 includes a wavelength separator 13-3. The wavelength separator 13-3 includes a concave lens 130, a dichroic cross prism 134, a convex lens 135, a convex lens 136, a convex lens 137, a communication light receiving element 141, a communication light receiving element 142, and a communication light receiving element 143.

In FIG. 9, the concave lens 130 is disposed at an incident port of the wavelength separator 13-3. The incident surface of the concave lens 130 faces the ball lens 11. The signal light S₃ incident on the concave lens 130 is emitted from the emission surface. The emitted signal light S₃ travels along the optical axis of the concave lens 130.

The dichroic cross prism 134 is disposed at a subsequent stage of the concave lens 130. The dichroic cross prism 134 reflects the signal light having the wavelength λ₁ downward. The dichroic cross prism 134 reflects the signal light having the wavelength λ₂ upward. The signal light having the wavelength λ₃ is transmitted through the dichroic cross prism 134.

The convex lens 135 is disposed below the dichroic cross prism 134. The incident surface of the convex lens 135 faces the upper dichroic cross prism 134. The communication light receiving element 141 is disposed below the convex lens 135. The light receiving part of the communication light receiving element 141 faces the emission surface of the convex lens 135 disposed above. The signal light having the wavelength λ₁ reflected downward by the dichroic cross prism 134 is condensed by the convex lens 135 and received by the communication light receiving element 141.

The convex lens 136 is disposed above the dichroic cross prism 134. The incident surface of the convex lens 136 faces the lower dichroic cross prism 134. The communication light receiving element 142 is disposed above the convex lens 136. The light receiving part of the communication light receiving element 142 faces the emission surface of the convex lens 136 disposed below. The signal light having the wavelength λ₂ reflected upward by the dichroic cross prism 134 is condensed by the convex lens 136 and received by the communication light receiving element 142.

The convex lens 137 is disposed at a subsequent stage of the dichroic cross prism 134. The incident surface of the convex lens 137 faces the back surface of the dichroic cross prism 134. The communication light receiving element 143 is disposed at a subsequent stage of the convex lens 137. The light receiving part of the communication light receiving element 143 faces the emission surface of the convex lens 137. The signal light having the wavelength λ₃ transmitted through the dichroic cross prism 134 is condensed by the convex lens 137 and received by the communication light receiving element 143.

### [Light Transmitter]

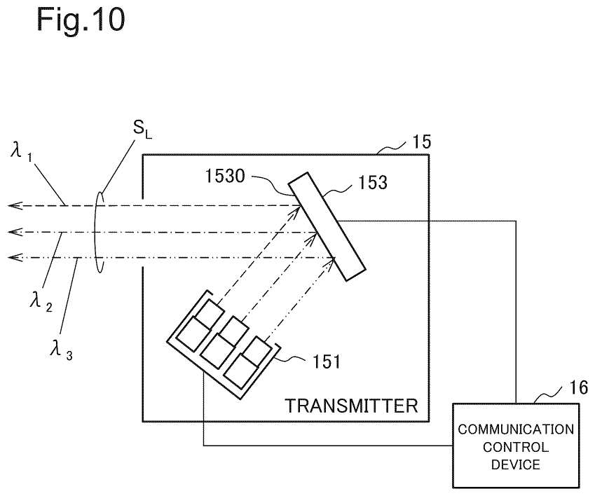

FIG. 10 is a conceptual diagram illustrating an example of a configuration of a light transmitter 15 in the present disclosure. FIG. 10 is a diagram illustrating the internal configuration of the light transmitter 15 as viewed from a side. FIG. 10 illustrates an example in which light in the Fraunhofer region is used. The light transmitter 15 includes a light source 151 and a spatial light modulator 153. FIG. 10 conceptually illustrates a positional relationship between the light source 151 and the spatial light modulator 153. FIG. 10 does not limit the positional relationship between the light source 151 and the spatial light modulator 153.

The light source 151 includes a plurality of emitters. In the example of FIG. 10, the light source 151 includes an emitter that emits light having the wavelength λ₁, an emitter that emits light having the wavelength λ₂, and an emitter that emits light having the wavelength λ₃. The plurality of emitters are disposed inside the housing of the light source 151 with the emission surface facing obliquely upward. The emission surface of the light source 151 faces a modulation part 1530 of the spatial light modulator 153 disposed above. Each of the plurality of emitters emits light emitted under the control of the communication control device 16.

A collimator is disposed in each of the plurality of emitters. The collimator is disposed on the emission surface of the emitter. The collimator converts the light emitted from the emitter into parallel light. The parallel light (illumination light) converted by the collimator is emitted to the modulation part 1530 of the spatial light modulator 153. For example, each of the plurality of emitters is associated with at least one of the plurality of modulation regions set in the modulation part 1530 of the spatial light modulator 153. The illumination light derived from the light emitted from each of the plurality of emitters travels toward the associated modulation region.

The plurality of emitters included in the light source 151 emit laser light in different wavelength bands. The wavelength of the laser light emitted from the emitter is not particularly limited, and may be selected according to the application. For example, the emitter emits the laser light in visible or infrared wavelength bands. In the present example embodiment, a silicon-based photodiode for search and an InGaAs-based photodiode for communication are selectively used. The silicon-based photodiode has sensitivity around 850 nm. The photodiode of InGaAs has sensitivity around 1550 nm. For example, in the case of near infrared rays of 800 to 1000 nm, the laser class can be given compared to the visible light, and thus the sensitivity can be improved more than the visible light. For example, a laser light source having a higher output than the near infrared rays of 800 to 1000 nm for infrared rays can be used in a wavelength band of 1.55 micrometers (μm). As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. For example, the emitter may be achieved by a surface emitting element such as a photonic crystal surface emitting laser (PCSEL).

For example, the light source 151 may include a plurality of emitters that emit light of the same wavelength band. For example, the light source 151 is achieved by a laser array in which a plurality of emitters are arranged in an array. For example, a laser array has a plurality of emitters arranged in 4 rows×2 columns. For example, the light source 151 may be a combination of a plurality of emitters that emit illumination light of the same wavelength band and an emitter that emits illumination light of a wavelength band different from those of the plurality of emitters. For example, the light source 151 may have a configuration in which an emitter that emits laser light in a wavelength band used for communication with a communication target and an emitter that emits laser light in a wavelength band different from the wavelength band of the laser light are combined. For example, one of the plurality of emitters constituting the laser array is a search emitter, and the others are communication emitters. For example, the search emitter emits light in a wavelength band of 850 nm. In that case, a silicon-based photodiode is used as the search light receiving element. For example, the communication emitter emits light in a wavelength band of 1550 nm. In this case, an InGaAs-based photodiode is used as the communication light receiving element. If the laser array is formed in this manner, search is performed using the search emitter (850 nm), and when the search is completed, communication is switched to communication using the communication emitter (1550 nm).

The spatial light modulator 153 is a phase modulation-type spatial light modulator. The spatial light modulator 153 includes the modulation part 1530. The spatial light modulator 153 is disposed obliquely above the light source 151. The modulation part 1530 of the spatial light modulator 153 faces the emission surface of the light source 151. The illumination light emitted to the modulation part 1530 of the spatial light modulator 153 is modulated according to the pattern (phase image) set in the modulation part 1530. The modulation light modulated by the modulation part 1530 is transmitted as a spatial optical signal. The traveling direction of the spatial optical signal (modulation light) can be adjusted according to the set pattern (phase image) of the modulation part 1530.

For example, the spatial light modulator 153 is achieved by a spatial light modulator using ferroelectric liquid crystal, homogeneous liquid crystal, vertical alignment liquid crystal, or the like. For example, the spatial light modulator 153 can be achieved by liquid crystal on silicon (LCOS). The spatial light modulator 153 may be achieved by a micro electro mechanical system (MEMS). In the spatial light modulator 153 of the phase modulation type, the energy can be concentrated on the portion of the image by operating to sequentially switch the portion used for the communication of the spatial optical signal S_{L}. Therefore, in the case of using the spatial light modulator 153 of the phase modulation type, if the output of the emitter included in the light source 151 is the same, the image can be displayed brighter than other methods.

At least one modulation region is set in the modulation part 1530 of the spatial light modulator 153. The number of modulation regions set in the modulation part 1530 is set in accordance with the number of emitters included in the light source 151. Each of the plurality of modulation regions is associated with one of the plurality of emitters included in the light source 151. Each of the plurality of modulation regions is irradiated with the illumination light derived from the laser light emitted from the associated emitter. However, the correspondence relationship between the modulation region and the emitter is not particularly limited as long as the illumination light derived from the laser light emitted from the emitter is incident on the modulation surface of the modulation region. The number of modulation regions set in the modulation part 1530 may be different from the number of emitters included in the light source 151.

The modulation region is divided into a plurality of regions (also referred to as tiling). A phase image is assigned to each of the plurality of tiles. Each of the plurality of tiles includes a plurality of pixels. A phase image relevant to a projected image is set to each of the plurality of tiles. A phase image is tiled to each of the plurality of tiles allocated to the modulation region. For example, a phase image generated in advance is set in each of the plurality of tiles. When the modulation region is irradiated with the illumination light in a state where the phase image is set in the plurality of tiles, the modulation light is emitted to form an image relevant to the phase image of each tile. As the number of tiles set in the modulation region increases, a clear image can be displayed. However, when the number of pixels of each tile decreases, the resolution decreases. Therefore, the size and number of tiles set in the modulation region are set according to the application.

A pattern (also referred to as a phase image) relevant to the image displayed by the spatial optical signal S_{L} is set in each of the plurality of modulation regions under the control of the communication control device 16. A pattern (phase image) is set in each of the plurality of modulation regions. The illumination light with which each of the plurality of modulation regions is irradiated is modulated according to a pattern (phase image) set in the modulation region. The modulation light modulated in each of the plurality of modulation regions is transmitted as the spatial optical signal S_{L}.

For example, a shield (not illustrated) may be disposed at a subsequent stage of the spatial light modulator 153. The shield is a frame that shields unnecessary light components included in the modulation light and defines an outer edge of a display region of the projection light. For example, the shield is an aperture. In such an aperture, a slit-shaped opening is formed in a portion through which light (desired light) for forming a desired image passes. The desired light is first-order diffracted light. The shield pass the desired light and blocks unwanted light components. For example, the shield blocks a ghost image including 0th-order light included in the modulation light, unnecessary first-order light appearing at a point symmetric position with respect to desired light with the 0th-order light as a center, and second and higher-order light. Details of the shield will not be described. For example, a projection lens (not illustrated) may be disposed at a subsequent stage of the spatial light modulator 153. When the concave lens is used as the projection lens, the beam diameter of the spatial optical signal S_{L} can be reduced according to the focal length of the concave lens.

### [Communication Control Device]

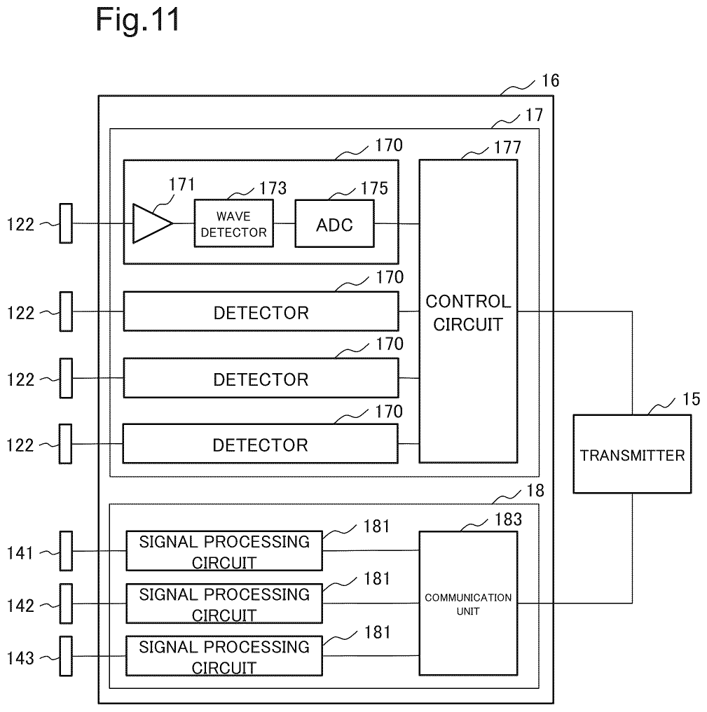

FIG. 11 is a conceptual diagram illustrating an example of a configuration of the communication control device 16. The communication control device 16 includes a direction detection circuit 17 and a communication circuit 18. The direction detection circuit 17 includes a plurality of detectors 170 and a control circuit 177. The communication circuit 18 includes a plurality of signal processing circuits 181 and a communication unit 183.

Each of the plurality of detectors 170 is connected to each of the plurality of direction detecting light receiving elements 122. The plurality of detectors 170 are connected to the control circuit 177. The detector 170 includes an amplifier 171, a wave detector 173, and a conversion circuit 175. In FIG. 11, the conversion circuit 175 is denoted as an analog-to-digital converter (ADC). The plurality of detectors 170 may include a filter relevant to a modulation frequency to be received. The filter cuts a signal derived from ambient light such as sunlight.

The amplifier 171 is connected to the direction detecting light receiving element 122. An electric signal derived from the signal light received by the direction detecting light receiving element 122 is input to the amplifier 171. The amplifier 171 amplifies the input electric signal with a set amplification factor. For example, the influence of sunlight can be removed if only the AC component of the signal from the direction detecting light receiving element 122 is amplified. The amplification factor of the amplifier 171 can be arbitrarily set. The electric signal amplified by the amplifier 171 is output to the wave detector 173.

The signal of the modulation frequency to be received amplified by the amplifier 171 is input to the wave detector 173. The wave detector 173 detects the input signal. An amplifier may be disposed at a subsequent stage of the wave detector 173. The signal detected by the wave detector 173 is supplied to the conversion circuit 175.

The signal detected by the wave detector 173 is input to the conversion circuit 175. The conversion circuit 175 converts an input signal (analog signal) into a digital signal. The converted digital signal is output to the control circuit 177.

A signal derived from the signal light received by each of the plurality of direction detecting light receiving elements 122 is input to the control circuit 177. The control circuit 177 detects the arrival direction of the spatial optical signal according to the light receiving situation of the signal light by each of the plurality of direction detecting light receiving elements 122.

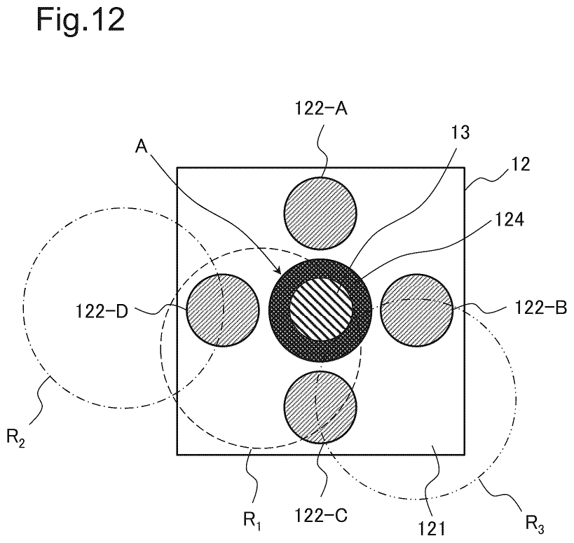

FIG. 12 is a conceptual diagram for explaining detection of the arrival direction of the spatial optical signal by the control circuit 177. FIG. 12 is a conceptual diagram of the light receiving surface of the irradiation position detector 12 as viewed from a side of the ball lens 11. In FIG. 12, alphabets (A, B, C, D) are added to the end of the reference numerals representing the plurality of direction detecting light receiving elements 122 to distinguish the direction detecting light receiving elements. FIG. 12 illustrates an inner surface of the light guide tube 124 and the wavelength separator 13. The plurality of direction detecting light receiving elements 122 are arranged on the circumference of a circle centered on the wavelength separator 13. In FIG. 12, an example of a condensing range of light condensed by the ball lens 11 is indicated by a circle.

The signal light emitted within the range of the condensing range R₁ (broken line) is received by a direction detecting light receiving element 122-C and a direction detecting light receiving element 122-D. The control circuit 177 sets the transmission direction of the spatial optical signal in the light transmitter 15 according to the light receiving situation of the signal light by the direction detecting light receiving element 122-C and the direction detecting light receiving element 122-D. The signal light emitted within the range of the condensing range R₁ (broken line) is received by the light receiving element group 14. The control circuit 177 may set the transmission direction of the spatial optical signal including the light receiving situation of the signal light by the light receiving element group 14. The control circuit 177 may set the transmission direction of the spatial optical signal according to the intensity of the signal light received by the direction detecting light receiving element 122-C and the direction detecting light receiving element 122-D. In a case where the signal light is emitted within the range of the condensing range R₁ (broken line), the spatial optical signal arrives from the upper left direction as viewed from a side of the light receiving surface. Therefore, the control circuit 177 outputs a control signal for directing the transmission direction of the spatial optical signal to the upper left direction to the light transmitter 15. The control circuit 177 controls the transmission direction of the spatial optical signal by changing the pattern (phase image) of the modulation part 1530 of the spatial light modulator 153.

The signal light emitted within the condensing range R₂ (one-dot chain line) is received by the direction detecting light receiving element 122-D. The control circuit 177 sets the transmission direction of the spatial optical signal in the light transmitter 15 according to the light receiving situation of the signal light by the direction detecting light receiving element 122-D. In a case where the signal light is emitted within the range of the light condensing range R₂ (one-dot chain line), the spatial optical signal arrives from the left direction as viewed from a side of the light receiving surface. Therefore, the control circuit 177 outputs a control signal for directing the transmission direction of the spatial optical signal to the left direction to the light transmitter 15. The control circuit 177 controls the transmission direction of the spatial optical signal by changing the pattern (phase image) of the modulation part 1530 of the spatial light modulator 153.

The signal light emitted within the condensing range R₃ (two-dot chain line) is received by the direction detecting light receiving element 122-B and the direction detecting light receiving element 122-C. The control circuit 177 sets the transmission direction of the spatial optical signal in the light transmitter 15 according to the light receiving situation of the signal light by the direction detecting light receiving element 122-B and the direction detecting light receiving element 122-C. The control circuit 177 may set the transmission direction of the spatial optical signal according to the intensity of the signal light received by the direction detecting light receiving element 122-B and the direction detecting light receiving element 122-C. In a case where the signal light is emitted within the range of the light condensing range R₃ (two-dot chain line), the spatial optical signal arrives from the upper right direction as viewed from a side of the light receiving surface. Therefore, the control circuit 177 outputs a control signal for directing the transmission direction of the spatial optical signal to the upper right direction to the light transmitter 15. The control circuit 177 controls the transmission direction of the spatial optical signal by changing the pattern (phase image) of the modulation part 1530 of the spatial light modulator 153.

In a case where the orientation of the light receiving surface of the light receiver 10 can be changed, the control circuit 177 may be formed to perform control to change the orientation of the light receiving surface of the light receiver 10 according to the light receiving situation of the signal light. For example, if the light receiver 10 is arranged so as to be movable in a horizontal plane and a vertical plane along a track centered on the ball lens 11, the orientation of the light receiving surface of the light receiver 10 can be freely changed.

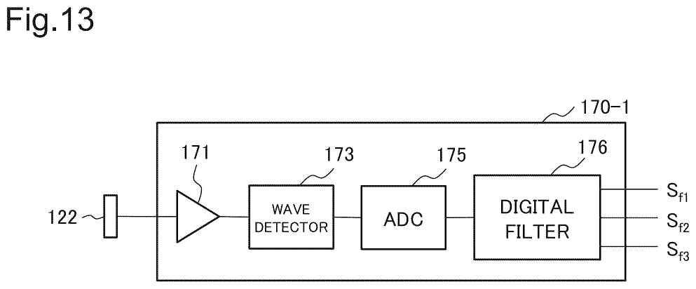

FIG. 13 is a conceptual diagram illustrating another example (detector 170-1) of the detector 170. The detector 170-1 includes a digital filter 176. The digital filter 176 separates the signal light received by the direction detecting light receiving element 122 for each frequency band to be received. In the case of the example of FIG. 13, the digital filter 176 wavelength-separates a signal S_{f1} of a modulation frequency f₁, a signal S_{f2} of a modulation frequency f₂, and a signal S_{f3} of a modulation frequency f₃ from the signal light received by the direction detecting light receiving element 122. The number of frequency bands to be received is not limited to three, and may be four or more. By using the detector 170-1, signals in a plurality of frequency bands can be separated from the signal light received by the single direction detecting light receiving element 122. Each of the plurality of signal processing circuits 181 is connected to any one of the plurality of communication light receiving elements included in the light receiving element group 14. In the example of FIG. 11, each of the plurality of signal processing circuits 181 is connected to any one of the communication light receiving element 141, the communication light receiving element 142, and the communication light receiving element 143. The plurality of signal processing circuits 181 are connected to the communication unit 183. In FIG. 11, the internal configuration of the signal processing circuit 181 is omitted.

The signal processing circuit 181 acquires an electric signal derived from the signal light received by any of the plurality of communication light receiving elements included in the light receiving element group 14. The signal processing circuit 181 amplifies the acquired electric signal. The signal processing circuit 181 converts the amplified electric signal from an analog signal to a digital signal. The signal processing circuit 181 outputs the converted digital signal to the communication unit 183. For example, the signal processing circuit 181 may be provided with a limiting amplifier (not illustrated) in front of an amplifier (not illustrated). When the limiting amplifier is provided, a dynamic range can be secured. For example, the signal processing circuit 181 may be provided with a filter (not illustrated) such as a high-pass filter, a low-pass filter, or a band-pass filter. The high-pass filter or the band-pass filter cuts off a signal derived from ambient light such as sunlight, and selectively passes a signal of a high frequency component relevant to a wavelength band of the spatial optical signal.

The communication unit 183 decodes the signal output from the signal processing circuit 181. The communication unit 183 individually decodes a signal for each frequency band included in the spatial optical signal transmitted from the communication target. The communication unit 183 causes the light transmitter 15 to transmit the spatial optical signal for each frequency band according to the decoded signal for each frequency band. As described above, the communication device 1 according to the present example embodiment can transmit and receive the spatial optical signals multiplexed in a plurality of frequency bands.

### [Communication Establishment]

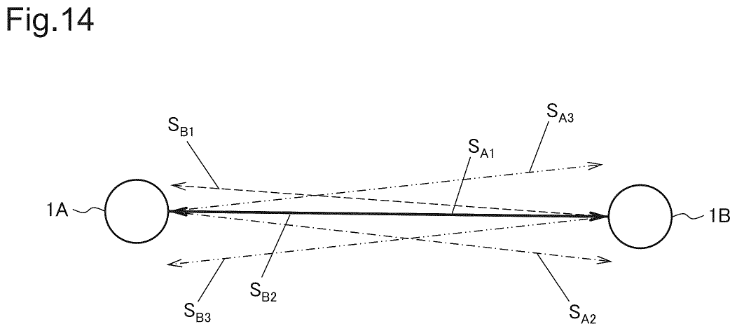

FIG. 14 is a conceptual diagram for explaining communication establishment in a communication network including the communication device 1 of the present example embodiment. FIG. 14 relates to establishment of communication between a communication device 1A and a communication device 1B. The communication device 1A and the communication device 1B use spatial optical signals obtained by multiplexing spatial optical signals of three systems having different wavelengths. The communication device 1A transmits three systems of spatial optical signals of a spatial optical signal S_{A1} having a wavelength λ₁, a spatial optical signal S_{A2} having a wavelength λ₂, and a spatial optical signal S_{A}3 having a wavelength λ₃. The communication device 1B transmits three systems of spatial optical signals including a spatial optical signal S_{B1} having a wavelength λ₁, a spatial optical signal S_{B2} having a wavelength λ₂, and a spatial optical signal S_{B3} having a wavelength λ₃. The communication device 1A and the communication device 1B establish communication with the communication target independently for each wavelength by using spatial optical signals of different wavelengths.

The example of FIG. 14 illustrates a state in which communication by a spatial optical signal having a wavelength λ₁ is established between the communication device 1A and the communication device 1B. As illustrated in FIG. 14, if communication by the spatial optical signal of one system is established, for the other two systems for which communication is not established, an instruction to adjust the transmission direction of the spatial optical signal can be issued to the communication target at the stage when the spatial optical signal is received as much as possible. Therefore, for the other two systems for which communication is not established, the time spent for communication establishment is shortened as compared with the first one system.

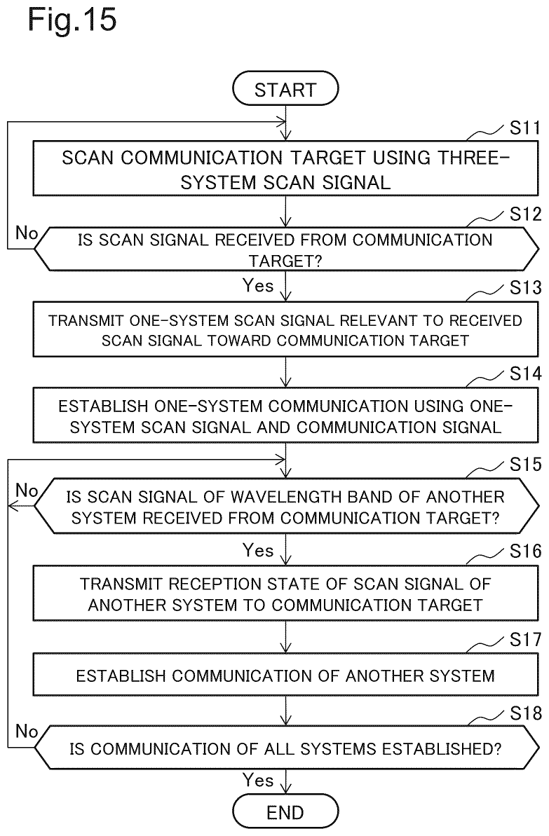

FIG. 15 is a flowchart for explaining an example of communication establishment in the present disclosure. In the description along the flowchart of FIG. 15, the communication device 1 will be described as an operation subject.

In FIG. 15, first, the communication device 1 scans a communication target by using scan signals of three systems (step S11).

If a scan signal is received from the communication target (Yes in step S12), the communication device 1 transmits a scan signal of one system relevant to the received scan signal toward the communication target (step S13). In a case where the scan signal has not been received from the communication target (No in step S12), the communication device 1 continues scanning using the scan signals of the three systems (step S11).

After step S13, the communication device 1 establishes communication of one system by using the scan signal and the communication signal of one system (step S14).

If a scan signal of a wavelength band of another system for which communication is not established is received from the communication target (Yes in step S15), the communication device 1 transmits a reception state of the scan signal of another system to the communication target (step S16). In a case where the scan signal of the wavelength band of another system has not been received from the communication target (No in step S15), the communication device 1 waits until the scan signal of the wavelength band of another system is received.

After step S16, the communication device 1 establishes communication of another system (step S17).

If the communication is established in all the systems (Yes in step S18), the communication device 1 ends the processing along the flowchart of FIG. 15 and performs the communication with the communication target using the spatial optical signals of all the systems. In a case where communication is not established in all the systems (No in step S18), the communication device 1 returns to the processing of step S15. In a situation where communication is not established in all the systems, the communication device 1 performs communication using a spatial optical signal of a system in which communication is already established.

### (Modifications)

Next, a modification of the irradiation position detector 12 included in the light receiver 10 of the present example embodiment will be described. Hereinafter, two modifications will be given. The first modification is an example in which a wavelength filter is disposed at a preceding stage of a photodiode sensitive to light in the same wavelength band. The second modification is an example in which photodiodes sensitive to light in different wavelength bands are used. The following modifications are examples, and do not limit the irradiation position detector 12 included in the light receiver 10 of the present example embodiment.

### [First Modification]

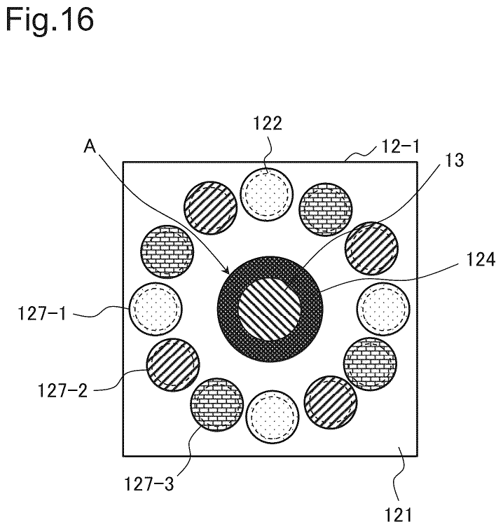

The first modification is an example in which a wavelength filter is arranged at a preceding stage of a photodiode sensitive to light of the same wavelength band. FIG. 16 is a conceptual diagram illustrating an example (irradiation position detector 12-1) of the irradiation position detector 12 according to the present disclosure. FIG. 16 is a front view of the light receiving surface of the irradiation position detector 12-1 as viewed from a side of the ball lens 11. In the present modification, light of a plurality of wavelength bands included in the spatial optical signal is modulated at modulation frequencies different from each other. The spatial optical signal is multiplexed with signals in the wavelength bands of the wavelength λ₁, the wavelength λ₂, and the wavelength λ₃.

The irradiation position detector 12-1 includes a substrate 121, a direction detecting light receiving element 122, a wavelength filter 127, and a light guide tube 124. Description of the substrate 121, the direction detecting light receiving element 122, and the light guide tube 124 is omitted. The irradiation position detector 12 includes a plurality of direction detecting light receiving elements 122. In the example of FIG. 16, the irradiation position detector 12-1 includes twelve direction detecting light receiving elements 122. The number of the direction detecting light receiving elements 122 is not limited to 12. The wavelength filters 127 are disposed one by one on the light receiving surfaces of the plurality of direction detecting light receiving elements 122. In the example of FIG. 16, four wavelength filters 127-1, four wavelength filters 127-2, and four wavelength filters 127-3 are arranged. The wavelength filter 127 may be arranged according to a wavelength band to be received.

The wavelength filter 127-1 selectively transmits the light having the wavelength λ₁. The wavelength filter 127-2 selectively transmits the light having the wavelength λ₂. The wavelength filter 127-3 selectively transmits the light having the wavelength λ₃. The wavelength λ₁, the wavelength λ₂, and the wavelength λ₃ are different from each other. The signal light having passed through each of the wavelength filters 127-1 to 127-3 is received by the direction detecting light receiving element 122 arranged at the subsequent stage.

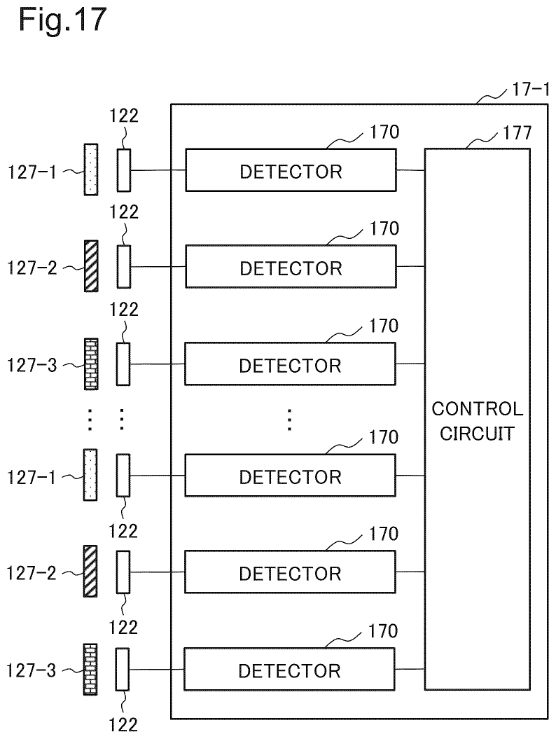

FIG. 17 is a conceptual diagram illustrating an example (direction detection circuit 17-1) of the direction detection circuit 17 according to the present modification. The direction detection circuit 17-1 includes a detector 170 for each of the plurality of direction detecting light receiving elements 122. The signal light having the wavelength λ₁ that has passed through the wavelength filter 127-1 is received by the direction detecting light receiving element 122 arranged at the subsequent stage. The signal light having the wavelength λ₂ that has passed through the wavelength filter 127-2 is received by the direction detecting light receiving element 122 arranged at the subsequent stage. The signal light having the wavelength λ₃ that has passed through the wavelength filter 127-3 is received by the direction detecting light receiving element 122 arranged at the subsequent stage. The plurality of direction detecting light receiving elements 122 output electric signals relevant to the received signal light to the detector 170 in the subsequent stage. Each of the plurality of detectors 170 amplifies, detects, and AD-converts the input electric signal, and outputs the amplified electric signal to the control circuit 177.

A signal derived from the signal light received by each of the plurality of direction detecting light receiving elements 122 is input to the control circuit 177. The control circuit 177 detects the arrival direction of the spatial optical signal according to the light receiving situation of the signal light by each of the plurality of direction detecting light receiving elements 122. The control circuit 177 detects the arrival direction of the spatial optical signal for each wavelength of the signal light. The control circuit 177 controls the transmission direction of the spatial optical signal for each wavelength by changing the pattern (phase image) of the modulation part 1530 of the spatial light modulator 153.

### [Second Modification]

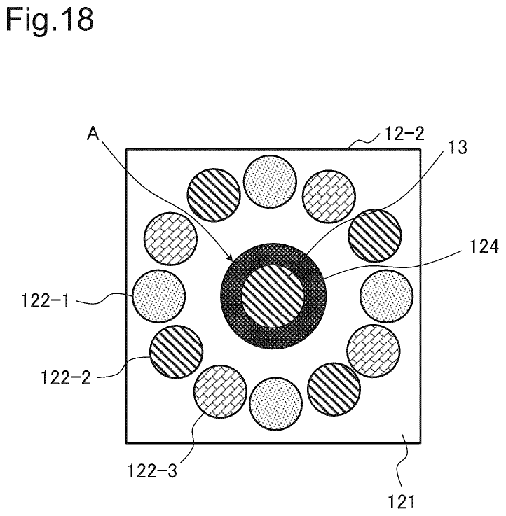

A second modification is an example in which photodiodes sensitive to light in different wavelength bands are used. FIG. 18 is a conceptual diagram illustrating an example (irradiation position detector 12-2) of the irradiation position detector 12 according to the present disclosure. FIG. 18 is a front view of the light receiving surface of the irradiation position detector 12-2 as viewed from a side of the ball lens 11. In the present modification, light of a plurality of wavelength bands included in the spatial optical signal is modulated at modulation frequencies different from each other. The spatial optical signal is multiplexed with signals in the wavelength bands of the wavelength λ₁, the wavelength λ₂, and the wavelength λ₃. The signal having the wavelength λ₁ is modulated at the modulation frequency f₁. The signal having the wavelength λ₂ is modulated at the modulation frequency f₂. The signal having the wavelength λ₃ is modulated at the modulation frequency f₃.

The irradiation position detector 12-2 includes a substrate 121, a direction detecting light receiving element 122, and a light guide tube 124. Description of the substrate 121 and the light guide tube 124 is omitted. The irradiation position detector 12 includes a plurality of direction detecting light receiving elements 122. In the example of FIG. 18, the irradiation position detector 12-2 includes four direction detecting light receiving elements 122-1, four direction detecting light receiving elements 122-2, and four direction detecting light receiving elements 122-3. The number of each of the direction detecting light receiving elements 122-1 to 122-3 is not limited to four. The direction detecting light receiving element 122-1 is sensitive to light having a wavelength λ₁. The direction detecting light receiving element 122-2 is sensitive to light having a wavelength λ₂. The direction detecting light receiving element 122-3 is sensitive to light having a wavelength λ₃.

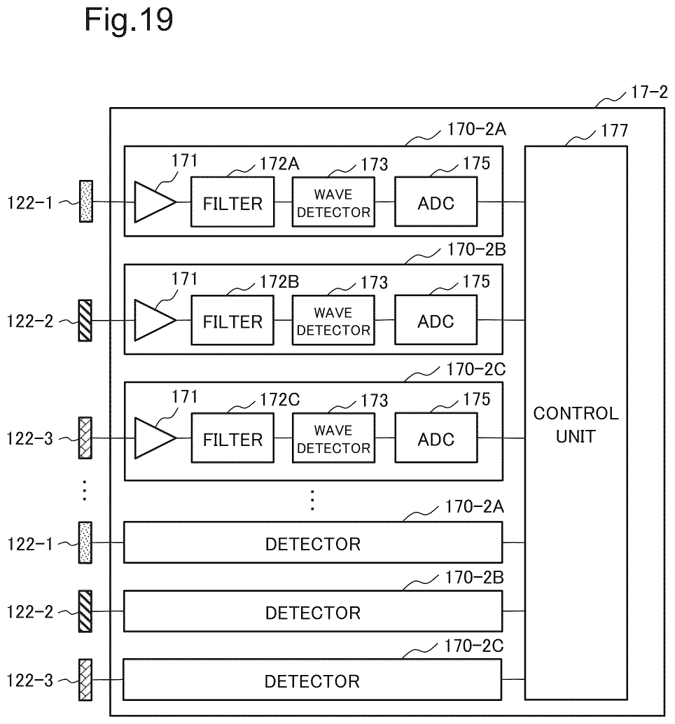

FIG. 19 is a conceptual diagram illustrating an example (direction detection circuit 17-2) of the direction detection circuit 17 according to the present modification. The direction detection circuit 17-2 includes detectors 170 (detector 170-2A, detector 170-2B, detector 170-2C) for the plurality of direction detecting light receiving elements 122-1 to 122-3. The detector 170-2A is connected to the direction detecting light receiving element 122-1. The detector 170-2B is connected to the direction detecting light receiving element 122-2. The detector 170-2C is connected to the direction detecting light receiving element 122-3.

The detector 170-2A includes an amplifier 171, a filter 172A, a wave detector 173, and a conversion circuit 175. An electric signal derived from the signal light having the wavelength λ₁ received by the direction detecting light receiving element 122-1 is input to the amplifier 171 of the detector 170-2A. The amplifier 171 amplifies the input electric signal with a set amplification factor. The electric signal amplified by the amplifier 171 is output to the filter 172A. An electric signal derived from the signal light having the wavelength λ₁ is input to the filter 172A. The filter 172A selectively passes the modulation frequency f₁ of the signal having the wavelength λ₁. The signal that has passed through the filter 172A is input to the wave detector 173. The signal of the modulation frequency f₁ to be received that has passed through the filter 172A is input to the wave detector 173. The wave detector 173 detects the input signal. The signal detected by the wave detector 173 is supplied to the conversion circuit 175. The signal detected by the wave detector 173 is input to the conversion circuit 175. The conversion circuit 175 converts an input signal (analog signal) into a digital signal. The converted digital signal is output to the control circuit 177.

The detector 170-2B includes an amplifier 171, a filter 172B, a wave detector 173, and a conversion circuit 175. An electric signal derived from the signal light having the wavelength λ₂ received by the direction detecting light receiving element 122-2 is input to the amplifier 171 of the detector 170-2B. The amplifier 171 amplifies the input electric signal with a set amplification factor. The electric signal amplified by the amplifier 171 is output to the filter 172B. An electric signal derived from the signal light having the wavelength λ₂ is input to the filter 172B. The filter 172B selectively passes the modulation frequency f₂ of the signal having the wavelength λ₂. The signal that has passed through the filter 172B is input to the wave detector 173. The signal of the modulation frequency f₂ to be received that has passed through the filter 172B is input to the wave detector 173. The wave detector 173 detects the input signal. The signal detected by the wave detector 173 is supplied to the conversion circuit 175. The signal detected by the wave detector 173 is input to the conversion circuit 175. The conversion circuit 175 converts an input signal (analog signal) into a digital signal. The converted digital signal is output to the control circuit 177.

The detector 170-2C includes an amplifier 171, a filter 172C, a wave detector 173, and a conversion circuit 175. The amplifier 171 is connected to the direction detecting light receiving element 122-3. An electric signal derived from the signal light having the wavelength λ₃ received by the direction detecting light receiving element 122-3 is input to the amplifier 171 of the detector 170-2C. The amplifier 171 amplifies the input electric signal with a set amplification factor. The electric signal amplified by the amplifier 171 is output to the filter 172C. An electric signal derived from the signal light having the wavelength λ₃ is input to the filter 172C. The filter 172C selectively passes the modulation frequency f₃ of the signal having the wavelength λ₃. The signal that has passed through the filter 172C is input to the wave detector 173. The signal of the modulation frequency f₃ to be received that has passed through the filter 172C is input to the wave detector 173. The wave detector 173 detects the input signal. The signal detected by the wave detector 173 is supplied to the conversion circuit 175. The signal detected by the wave detector 173 is input to the conversion circuit 175. The conversion circuit 175 converts an input signal (analog signal) into a digital signal. The converted digital signal is output to the control circuit 177.

A signal derived from the signal light received by each of the plurality of direction detecting light receiving elements 122-1 to 122-3 is input to the control circuit 177. The control circuit 177 detects the arrival direction of the spatial optical signal according to the light receiving situation of the signal light by each of the plurality of direction detecting light receiving elements 122-1 to 122-3. The control circuit 177 detects the arrival direction of the spatial optical signal for each wavelength (modulation frequency) of the signal light. The control circuit 177 controls the transmission direction of the spatial optical signal for each wavelength by changing the pattern (phase image) of the modulation part 1530 of the spatial light modulator 153 (modulation frequency).

### Application Example

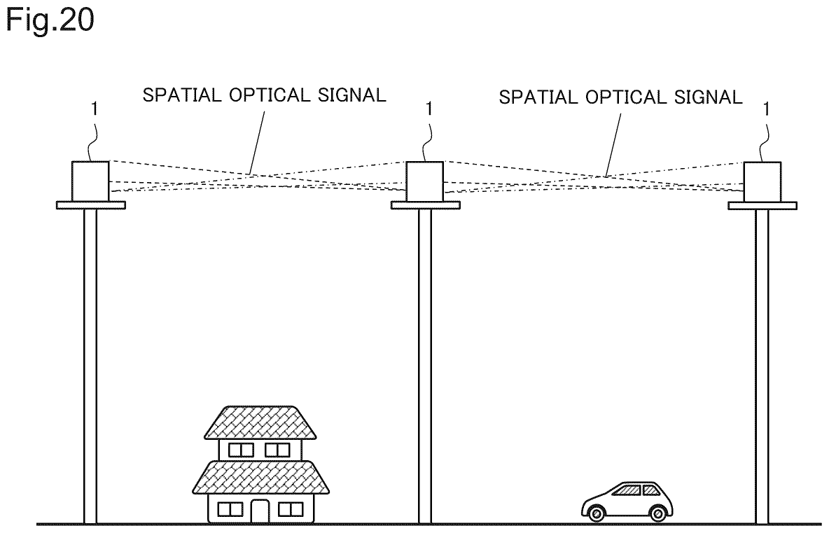

Next, an application example of the present example embodiment will be described with reference to the drawings. In the following application example, an example in which a plurality of communication devices 1 transmit and receive spatial optical signals will be described. FIG. 20 is a conceptual diagram for explaining the present application. In the present application example, an example (communication system) of a communication network including a plurality of communication devices 1 are disposed on an upper portion (space above a pole) of a pole such as a utility pole or a street lamp disposed in a town will be described.

There are few obstacles in the space above the pole. Therefore, the space above the pillar is suitable for installing the communication device 1. If the communication device 1 is installed at the same height, the arrival direction of the spatial optical signal is limited to the horizontal direction. The pair of communication devices 1 transmitting and receiving the spatial optical signal S_{L} is disposed at a position where at least one communication device 1 receives the spatial optical signal transmitted from the other communication device 1. The pair of communication devices 1 may be disposed to transmit and receive spatial optical signals to and from each other. In a case where a communication network of spatial optical signals includes a plurality of communication devices 1, the communication device 1 positioned in the middle may relay a spatial optical signal transmitted from another communication device 1 to another communication device 1.

According to the present application example, it is possible to perform communication using a spatial optical signal among the plurality of communication devices 1 disposed in the space above the pole. For example, in accordance with the communication among the communication devices 1, communication by radio communication may be performed between the communication device 1 and a radio device or a base station installed in an automobile, a house, or the like. For example, the communication device 1 may be connected to the Internet via a communication cable or the like installed on a pole.

As described above, the communication device according to the present example embodiment includes the light receiver, the light transmitter, and the communication control device. The light receiver includes a ball lens, an irradiation position detector, a wavelength separator, and a light receiving element group. The ball lens is a spherical lens. The irradiation position detector detects an irradiation position of the signal light condensed by the ball lens. The wavelength separator wavelength-separates signal light having a plurality of wavelengths used for spatial optical communication from the signal light condensed by the ball lens. The light receiving element group includes a plurality of communication light receiving elements that receive the signal light of a plurality of wavelengths wavelength-separated by the wavelength separator. The light transmitter transmits a wavelength-multiplexed spatial optical signal used for spatial optical communication. The communication control device detects the arrival direction of the spatial optical signal according to the irradiation position detected by the irradiation position detector included in the light receiver. The communication control device causes the light transmitter to transmit the spatial optical signal toward the detected arrival direction.

The light receiver of the present example embodiment wavelength-separates the signal light condensed by the ball lens. The light receiver according to the present example embodiment receives the wavelength-separated signal light by any of the plurality of communication light receiving elements. Therefore, the light receiver of the present example embodiment can receive the wavelength-multiplexed spatial optical signal with sufficient intensity.

In one aspect of the present example embodiment, the light receiving element group includes a first communication light receiving element and a second communication light receiving element. The first communication light receiving element is sensitive to the light of the first wavelength. The second communication light receiving element is sensitive to light of the second wavelength. The wavelength separator includes a dichroic mirror. The dichroic mirror reflects the signal light having the first wavelength toward the first communication light receiving element. The dichroic mirror transmits the signal light having the second wavelength toward the second communication light receiving element. According to the present aspect, a signal light having two wavelengths can be wavelength-separated using one dichroic mirror.

In one aspect of the present example embodiment, the light receiving element group includes a first communication light receiving element, a second communication light receiving element, and a third communication light receiving element. The first communication light receiving element is sensitive to the light of the first wavelength. The second communication light receiving element is sensitive to light of the second wavelength. The third communication light receiving element is sensitive to light of the third wavelength. The wavelength separator includes a first dichroic mirror and a second dichroic mirror. The first dichroic mirror reflects the signal light having the first wavelength toward the first communication light receiving element. The first dichroic mirror transmits the signal light having the second wavelength and the signal light having the third wavelength. The second dichroic mirror reflects the signal light having the second wavelength transmitted through the first dichroic mirror toward the second communication light receiving element. The second dichroic mirror transmits the signal light having the third wavelength transmitted through the first dichroic mirror toward the third communication light receiving element. According to the present aspect, a signal light having three wavelengths can be wavelength-separated using two dichroic mirrors.

In one aspect of the present example embodiment, the light receiving element group includes a first communication light receiving element, a second communication light receiving element, and a third communication light receiving element. The first communication light receiving element is sensitive to the light of the first wavelength. The second communication light receiving element is sensitive to light of the second wavelength. The third communication light receiving element is sensitive to light of the third wavelength. The wavelength separator includes a dichroic cross prism. The dichroic cross prism reflects the signal light having the first wavelength toward the first communication light receiving element. The dichroic cross prism reflects the signal light having the second wavelength toward the second communication light receiving element. The dichroic cross prism transmits the signal light having the third wavelength toward the third communication light receiving element. According to the present aspect, it is possible to wavelength-separate signal light having three wavelengths by using one dichroic cross prism.

In one aspect of the present example embodiment, the irradiation position detector includes a substrate, a plurality of direction detecting light receiving elements, and a light guide tube. The substrate has a light receiving surface facing the ball lens and a back surface facing the light receiving surface. A through hole penetrating the light receiving surface and the back surface is opened in the substrate. The plurality of direction detecting light receiving elements are arranged around the through hole on the light receiving surface of the substrate with the light receiving part facing the ball lens. The light guide tube includes a light-receiving-surface-side opening end connected to the through hole and a rear-surface-side opening end connected to the wavelength separator. According to the present aspect, the arrival direction of the spatial optical signal can be detected using the plurality of direction detecting light receiving elements arranged around the through hole of the substrate.

In one aspect of the present example embodiment, the irradiation position detector includes a plurality of direction detecting light receiving elements associated with a plurality of wavelengths used for spatial optical communication. Wavelength filters that selectively transmit light of a wavelength to be received are arranged in the light receiving parts of the plurality of direction detecting light receiving elements. According to the present aspect, by using the wavelength filter that transmits the wavelength to be received, the wavelength-multiplexed signal light can be wavelength-separated.

In one aspect of the present example embodiment, the irradiation position detector includes a plurality of direction detecting light receiving elements associated with a plurality of wavelengths used for spatial optical communication. Each of the plurality of direction detecting light receiving elements is sensitive to light having an associated wavelength. According to the present aspect, by using the plurality of direction detecting light receiving elements associated with the plurality of wavelengths, the wavelength-multiplexed signal light can be wavelength-separated.

In one aspect of the present example embodiment, the light receiver includes a plurality of direction detecting light receiving elements arranged such that the light receiving part faces the ball lens. The communication control device detects the arrival direction of the spatial optical signal according to the light receiving situation of the signal light by the plurality of direction detecting light receiving elements. The communication control device causes the light transmitter to transmit the spatial optical signal including the information on the light receiving situation of the signal light by the plurality of direction detecting light receiving elements toward the detected arrival direction. According to the present aspect, the arrival direction of the spatial optical signal detected according to the light receiving situation of the signal light by the plurality of direction detecting light receiving elements can be notified to the communication target.

A communication system according to an aspect of the present example embodiment includes a plurality of the above-described communication devices. The plurality of communication devices are arranged so as to mutually transmit and receive spatial optical signals. According to the present aspect, it is possible to achieve a communication network that transmits and receives a spatial optical signal.

### Second Example Embodiment

Next, a light receiver according to a second example embodiment will be described with reference to the drawings. The light receiver of the present example embodiment has a simplified configuration of the light receiver of the first example embodiment.

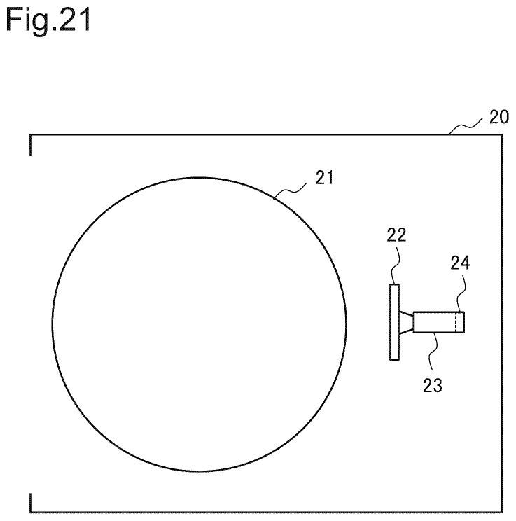

FIG. 21 is a conceptual diagram illustrating an example of a configuration of a light receiver 20 according to the present disclosure. The light receiver 20 includes a ball lens 21, an irradiation position detector 22, a wavelength separator 23, and a light receiving element group 24.

The ball lens 21 is a spherical lens. The irradiation position detector 22 detects an irradiation position of the signal light condensed by the ball lens 21. The wavelength separator 23 wavelength-separates a signal light having a plurality of wavelengths used for spatial optical communication from the signal light condensed by the ball lens 21. The light receiving element group 24 includes a plurality of communication light receiving elements that receive a signal light having a plurality of wavelengths wavelength-separated by the wavelength separator 23.

The light receiver of the present example embodiment wavelength-separates the signal light condensed by the ball lens. The light receiver according to the present example embodiment receives the wavelength-separated signal light by any of the plurality of communication light receiving elements. Therefore, the light receiver of the present example embodiment can receive the wavelength-multiplexed spatial optical signal with sufficient intensity.

### (Hardware)

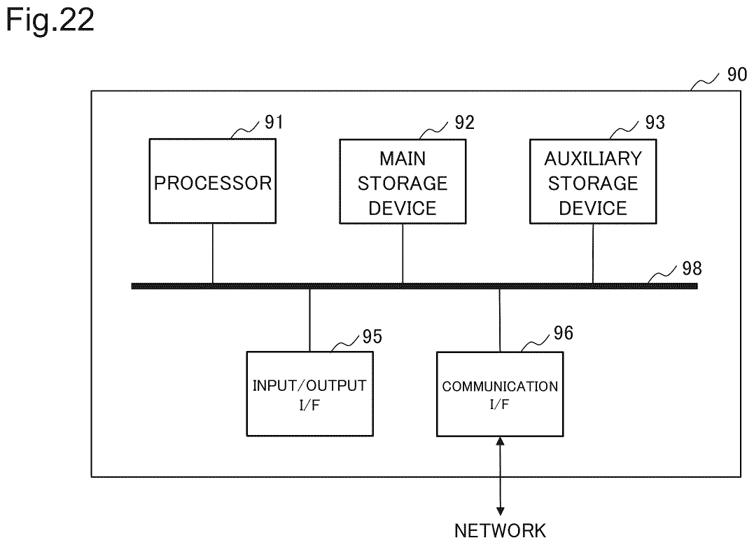

Next, a hardware configuration for executing control and processing in the present disclosure will be described with reference to the drawings. Here, an example of such a hardware configuration is an information processing device 90 (computer) in FIG. 22. The information processing device 90 in FIG. 22 is a configuration example for executing the control and processing of the present disclosure, and does not limit the scope of the present disclosure.

As illustrated in FIG. 22, the information processing device 90 includes a processor 91, a main storage device 92, an auxiliary storage device 93, an input/output interface 95, and a communication interface 96. In FIG. 22, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing the control and processing in the present disclosure. The processor 91 executes the program developed in the main storage device 92. The processor 91 executes the control and processing in the present disclosure by executing the program.

The main storage device 92 has a region in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magneto resistive random access memory (MRAM) may be formed and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device based on a standard and a specification. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing in the present disclosure. The hardware configuration of FIG. 22 is an example of a hardware configuration for executing the control and processing in the present disclosure, and does not limit the scope of the present disclosure. A program for causing a computer to execute the control and processing in the present disclosure is also included in the scope of the present disclosure.

Further, a program recording medium in which the program executing processing in the present example embodiment is recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium.

The components in the present disclosure may be arbitrarily combined. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above example embodiments may be described as the following Supplementary Notes, but are not limited to the following.

### (Supplementary Note 1)

A light receiver including:
a ball lens;
an irradiation position detector that detects an irradiation position of a signal light condensed by the ball lens;
a wavelength separator that wavelength-separates a signal light having a plurality of wavelengths used for spatial optical communication from a signal light condensed by the ball lens; and
a light receiving element group including a plurality of communication light receiving elements that receive a signal light having the plurality of wavelengths wavelength-separated by the wavelength separator.

### (Supplementary Note 2)

The light receiver according to Supplementary Note 1, in which
the light receiving element group includes:
a first communication light receiving element sensitive to light having a first wavelength; and
a second communication light receiving element sensitive to light having a second wavelength, and
the wavelength separator includes:
a dichroic mirror that reflects a signal light having the first wavelength toward the first communication light receiving element and transmits a signal light having the second wavelength toward the second communication light receiving element.

### (Supplementary Note 3)

The light receiver according to Supplementary Note 1, in which
the light receiving element group includes:
a first communication light receiving element sensitive to light having a first wavelength;
a second communication light receiving element sensitive to light having a second wavelength; and
a third communication light receiving element sensitive to light having a third wavelength, and
the wavelength separator includes:
a first dichroic mirror that reflects a signal light having the first wavelength toward the first communication light receiving element and transmits the signal light having the second wavelength and the signal light having the third wavelength; and
a second dichroic mirror that reflects a signal light having the second wavelength transmitted through the first dichroic mirror toward the second communication light receiving element, and transmits a signal light having the third wavelength transmitted through the first dichroic mirror toward the third communication light receiving element.

### (Supplementary Note 4)

The light receiver according to Supplementary Note 1, in which
the light receiving element group includes:
a first communication light receiving element sensitive to light having a first wavelength;
a second communication light receiving element sensitive to light having a second wavelength;
a third communication light receiving element sensitive to light having a third wavelength, and
the wavelength separator includes:
a dichroic cross prism that reflects a signal light having the first wavelength toward the first communication light receiving element, reflects a signal light having the second wavelength toward the second communication light receiving element, and transmits a signal light having the third wavelength toward the third communication light receiving element.

### (Supplementary Note 5)

The light receiver according to Supplementary Note 1, in which
the irradiation position detector includes:
a substrate having a light receiving surface facing the ball lens and a back surface opposed to the light receiving surface, the substrate having a through hole penetrating the light receiving surface and the back surface;
a plurality of direction detecting light receiving elements arranged around the through hole on the light receiving surface of the substrate with a light receiving part facing the ball lens; and
a light guide tube including a light-receiving-surface-side opening end connected to the through hole and a rear-surface-side opening end connected to the wavelength separator.

### (Supplementary Note 6)

The light receiver according to Supplementary Note 5, in which
the irradiation position detector includes:
a plurality of the direction detecting light receiving elements associated with the plurality of wavelengths used for the spatial optical communication, and
a wavelength filter that selectively transmits light having a wavelength to be received is arranged in light receiving parts of the plurality of direction detecting light receiving elements.

### (Supplementary Note 7)

The light receiver according to Supplementary Note 5, in which
the irradiation position detector includes:
a plurality of the direction detecting light receiving elements associated with the plurality of wavelengths used for the spatial optical communication, and
each of the plurality of the direction detecting light receiving elements is sensitive to light having an associated wavelength.

### (Supplementary Note 8)

A communication device including:
a light receiver according to any one of Supplementary Notes 1 to 7;
a light transmitter that transmits a wavelength-multiplexed spatial optical signal used for the spatial optical communication; and
a communication control device that detects an arrival direction of a spatial optical signal according to an irradiation position detected by the irradiation position detector included in the light receiver, and causes the light transmitter to transmit a spatial optical signal toward a detected arrival direction.

### (Supplementary Note 9)

The communication device according to Supplementary Note 8, in which
the light receiver includes:
a plurality of direction detecting light receiving elements arranged with a light receiving part facing the ball lens, and
the communication control device detects an arrival direction of a spatial optical signal according to a light receiving situation of a signal light by a plurality of the direction detecting light receiving elements, and transmits the spatial optical signal including information on a light receiving situation of a signal light by a plurality of the direction detecting light receiving elements to the light transmitter toward a detected arrival direction.

### (Supplementary Note 10)

A communication system including:
a plurality of communication devices according to Supplementary Note 8, in which
a plurality of the communication devices are disposed to transmit and receive spatial optical signals to and from each other.

1. Alight receiver comprising:
a ball lens;
an irradiation position detector that detects an irradiation position of a signal light condensed by the ball lens;
a wavelength separator that wavelength-separates a signal light having a plurality of wavelengths used for spatial optical communication from the signal light condensed by the ball lens; and
a light receiving element group including a plurality of communication light receiving elements that receive a signal light having the plurality of wavelengths wavelength-separated by the wavelength separator.

2. The light receiver according to claim 1, wherein
the light receiving element group includes
a first communication light receiving element sensitive to light having a first wavelength, and
a second communication light receiving element sensitive to light having a second wavelength, and wherein
the wavelength separator includes
a dichroic mirror that reflects a signal light having the first wavelength toward the first communication light receiving element and transmits a signal light having the second wavelength toward the second communication light receiving element.

3. The light receiver according to claim 1, wherein
the light receiving element group includes
a first communication light receiving element sensitive to light having a first wavelength,
a second communication light receiving element sensitive to light having a second wavelength, and
a third communication light receiving element sensitive to light having a third wavelength, and wherein
the wavelength separator includes
a first dichroic mirror that reflects a signal light having the first wavelength toward the first communication light receiving element and transmits the signal light having the second wavelength and the signal light having the third wavelength; and
a second dichroic mirror that reflects a signal light having the second wavelength transmitted through the first dichroic mirror toward the second communication light receiving element, and transmits a signal light having the third wavelength transmitted through the first dichroic mirror toward the third communication light receiving element.

4. The light receiver according to claim 1, wherein
the light receiving element group includes
a first communication light receiving element sensitive to light having a first wavelength,
a second communication light receiving element sensitive to light having a second wavelength,
a third communication light receiving element sensitive to light having a third wavelength, and wherein
the wavelength separator includes
a dichroic cross prism that reflects a signal light having the first wavelength toward the first communication light receiving element, reflects a signal light having the second wavelength toward the second communication light receiving element, and transmits a signal light having the third wavelength toward the third communication light receiving element.

5. The light receiver according to claim 1, wherein
the irradiation position detector includes
a substrate having a light receiving surface facing the ball lens and a back surface opposed to the light receiving surface, the substrate having a through hole penetrating the light receiving surface and the back surface,
a plurality of direction detecting light receiving elements arranged around the through hole on the light receiving surface of the substrate with a light receiving part facing the ball lens, and
a light guide tube including a light-receiving-surface-side opening end connected to the through hole and a rear-surface-side opening end connected to the wavelength separator.

6. The light receiver according to claim 5, wherein
the irradiation position detector includes
a plurality of the direction detecting light receiving elements associated with the plurality of wavelengths used for the spatial optical communication, and
a wavelength filter that selectively transmits light having a wavelength to be received is arranged in light receiving parts of the plurality of direction detecting light receiving elements.

7. The light receiver according to claim 5, wherein
the irradiation position detector includes
the plurality of direction detecting light receiving elements associated with the plurality of wavelengths used for the spatial optical communication, and
each of the plurality of direction detecting light receiving elements is sensitive to light having an associated wavelength.

8. A communication device comprising:
a light receiver according to claim 1;
a light transmitter that transmits a wavelength-multiplexed spatial optical signal used for the spatial optical communication; and
a communication control device including
a memory storing instructions, and
a processor connected to the memory and configured to execute the instructions to
detect an arrival direction of a spatial optical signal according to an irradiation position detected by the irradiation position detector included in the light receiver, and
cause the light transmitter to transmit a spatial optical signal toward a detected arrival direction.

9. The communication device according to claim 8, wherein
the light receiver includes
a plurality of direction detecting light receiving elements arranged with a light receiving part facing the ball lens, and
the processor of the communication control device is configured to execute the instructions to
detect an arrival direction of a spatial optical signal according to a light receiving situation of a signal light by the plurality of direction detecting light receiving elements, and
transmit the spatial optical signal including information on a light receiving situation of a signal light by the plurality of direction detecting light receiving elements to the light transmitter toward a detected arrival direction.

10. A communication system comprising
a plurality of communication devices according to claim 8, wherein
the plurality of communication devices are disposed to transmit and receive spatial optical signals to and from each other.
